(19) United States
(12) Patent Application Publication
(10) Pub. No.: US 2012/0147426 A1
(43) Pub. Date: Jun. 14, 2012

(54) INFORMATION PROCESSING APPARATUS, INFORMATION PROCESSING METHOD, AND RECORDING MEDIUM

(75) Inventors: Akiteru Naka, Machida-shi (JP); Naohiro Isobe, Kawasaki-shi (JP)

(73) Assignee: CANON KABUSHIKI KAISHA, Tokyo (JP)

(21) Appl. No.: 13/310,386

(22) Filed: Dec. 2, 2011

(30) Foreign Application Priority Data
Dec. 9, 2010 (JP) 2010-274800

(51) Int. Cl. G06K 15/02

(52) U.S. Cl. 358/1.18

(57) ABSTRACT

There is provided an information processing apparatus capable of merging a plurality of print documents having a hierarchical structure including layers to which metadata are attached. To achieve this capability, the information processing apparatus receives from a user an instruction for merging the plurality of print documents, changes the plurality of print documents, and then merges the plurality of print documents.

### BACKGROUND OF THE INVENTION

1. Field of the Invention

Embodiments of the present invention relate to an information processing apparatus, an information processing method, and a recording medium.

2. Description of the Related Art

(1) Print on Demand (POD), Variable Printing, and Portable Document Format/Variable data and Transactional (PDF/VT)

Along with the popularization of printing systems for the POD market, variable printing for customizing and printing a printed product for each individual customer has attracted attention. Variable printing makes it possible to print documents read from a database, varying the contents on a page basis for each individual customer. Therefore, variable printing is advantageous in generating a printed product suitable for each individual customer. In such a trend, ISO 16612-2 PDF/VT standardization process is in progress as language specifications for variable printing. PDF/VT is characterized in that adding variable printing and transaction print specifications based on the Portable Document Format (PDF) enables utilizing PDF/VT even in an existing PDF work flow.

(2) Features of PDF/VT (Hierarchical Structure, Document Part (DPart) and metadata, and Document Part Metadata (DPM))

PDF/VT makes it possible to provide a hierarchical structure called a DPart to structure PDF pages and, at the same time, attach any metadata called a DPM to each DPart. Various pieces of information, such as “POST CODE”, “ADDRESS”, “NAME”, etc., maybe attached to metadata represented in a hierarchical structure (hierarchical metadata) based on a relation between a key and a value. PDF/VT has a root node regarding the hierarchical structure, called a Document Part Root (DPartRoot). Further, with metadata of the DPartRoot, record information acquired when the database is read is maintained as hierarchical metadata based on a relation between a key and a value, and the layer information is managed based on the key “RECORD LEVEL.”

With hierarchical metadata of PDF/VT, DParts may be added, deleted, and freely edited. Therefore, by attaching metadata to layers to give a meaning thereto, the layers may be used for the purpose of grouping.

(3) How is PDF/VT Used to Achieve Variable Printing?

Job Definition Format (JDF) is used together with page description language (PDL) data such as PDF/VT to control the entire printing work flow. When performing variable printing by using JDF and PDF/VT, customer information is acquired by referring to metadata of PDF/VT and customized for each individual customer, and printing is made. Further, an engine for reading JDF to perform imposition processing performs imposition processing by repetitively referring to record level layers of PDF/VT.

By using together with printing control information such as JDF, PDF/VT enables such printing control that only pages corresponding to a particular post code are printed based on hierarchical metadata. More specifically, with PDF/VT based on grouping by the post code, such control that only a particular group, i.e., a particular post code is printed is possible by using printing control information such as JDF.

As mentioned above, PDF/VT may achieve detailed printing control by providing hierarchical metadata and freely editing (grouping) layers.

(4) Why Editing PDF/VT is Difficult in Consideration of (3)?

However, even when the hierarchical structure of PDF/VT is changed by editing PDF/VT through grouping, it is naturally necessary that the key “RECORD LEVEL” is correctly managed. Further, to perform printing control, it is necessary not only to correctly manage the key “RECORD LEVEL” of PDF/VT itself but also to correctly maintain a reference in JDF. Accordingly, it is demanded to edit metadata represented by the hierarchical structure with a simple method, without destroying a reference relation.

Japanese Patent Application Laid-Open No. 11-205736 discusses a technique for graphically editing a hierarchical structure and metadata accompanying the hierarchical structure.

However, the above-mentioned conventional editing method does not take into consideration merging and dividing print data having a hierarchical structure, and, therefore, may not suitably divide print data having a hierarchical structure.

### SUMMARY OF THE INVENTION

One disclosed aspect of the embodiments is directed to an information processing apparatus capable of suitably dividing print data having a hierarchical structure.

According to an aspect of the embodiments, an information processing apparatus includes a receiving unit configured to receive from a user an instruction for merging first and second print documents having a hierarchical structure including layers to which metadata may be attached, a determination unit configured to, in response to the instruction received by the receiving unit, determine whether a combination of keys included in metadata of the first print document coincides with a combination of keys included in metadata of the second print document with respect to each of the layers in the hierarchical structures of the first and second print documents, a changing unit configured to, when the determination unit determines that the combination of keys included in the metadata of the first print document does not coincide with the combination of keys included in the metadata of the second print document, change at least one of the metadata of the first print document and the metadata of the second print document so that the combination of keys included in the metadata of the first print document coincides with the combination of keys included in the metadata of the second print document with respect to each of the layers in the hierarchical structures of the first and second print documents, and a merging unit configured to merge the first and second print documents based on the metadata obtained through change processing by the changing unit.

According to another aspect of the embodiments, an information processing apparatus includes a receiving unit configured to receives from a user an instruction for merging a plurality of print documents having a hierarchical structure including layers to which metadata may be attached, and a merging unit configured to acquire all keys of the metadata attached to the plurality of print documents, determine a hierarchical structure of a print document to be formed after merging, change the metadata of the plurality of print documents to achieve the determined hierarchical structure, and merge the plurality of print documents.

Further features and aspects of the embodiments will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the embodiments and, together with the description, serve to explain the principles of the embodiments.

FIG. 1 schematically illustrates a configuration of a POD system including a printing system according to a first exemplary embodiment.

FIG. 2 is a block diagram illustrating an exemplary hardware configuration of a client computer, which is an exemplary information processing apparatus.

FIG. 3 illustrates an exemplary functional configuration of the client computer, which is an exemplary information processing apparatus.

FIG. 4A illustrates an exemplary image of the hierarchical metadata in FIG. 3.

FIG. 4B illustrates an exemplary image of the hierarchical metadata in FIG. 4A after editing.

FIG. 4C illustrates an exemplary image of the hierarchical metadata in FIG. 3, different from the one in FIG. 4A.

FIG. 4D illustrates an exemplary image of the hierarchical metadata in FIG. 4A, represented in the XML format.

FIG. 5 illustrates an exemplary image of the printing control information in FIG. 3 in the hierarchical metadata in FIG. 4A.

FIG. 6A illustrates an exemplary image of a hierarchical metadata change screen of a user interface (UI) control unit, displaying the hierarchical metadata in FIG. 4A.

FIG. 6B illustrates an exemplary image of the hierarchical metadata change screen as a result of applying grouping by the key “PREFECTURE” to the hierarchical structure illustrated in FIG. 6A.

FIG. 6C illustrates an exemplary image of the hierarchical metadata change screen as a result of importing another print document into the hierarchical structure illustrated in FIG. 6B by pressing an import button.

FIG. 7 is a flowchart illustrating processing performed by the print document merging unit to merge a plurality of print documents to be merged.

FIG. 8 illustrates an exemplary image of merged hierarchical metadata resulting from applying the processing of the flowchart in FIG. 7 to the hierarchical metadata in FIGS. 4B and 4C.

FIG. 9 illustrates an exemplary image of hierarchical metadata in a certain print document.

FIG. 10 is a flowchart illustrating processing performed by the print document merging unit according to a second exemplary embodiment to merge a plurality of print documents.

FIG. 11 illustrates an exemplary image of merged hierarchical metadata resulting from applying the processing of the flowchart in FIG. 10 to the hierarchical metadata in FIGS. 9 and 4A.

FIG. 12A illustrates an exemplary image of the hierarchical metadata change screen of the UI control unit, displaying the hierarchical metadata in FIG. 4A.

FIG. 12B illustrates an exemplary image of the hierarchical metadata change screen of the UI control unit, displaying the hierarchical metadata in FIG. 4A after further grouping by the key “USE” is applied thereto.

FIG. 12C illustrates an exemplary division policy screen displayed when the user presses a DIVISION button in the hierarchical metadata change screens in FIG. 12A and FIG. 12B.

FIG. 13 is a flowchart illustrating processing performed by a print document dividing unit to divide a print document when division is instructed in the hierarchical metadata change screen.

FIGS. 14A1 and 14A2 illustrate exemplary images of divided hierarchical metadata resulting from applying the processing of the flowchart in FIG. 13 to the hierarchical metadata in FIG. 4A.

FIG. 14B illustrates an exemplary image of hierarchical metadata of a firstly divided print document resulting from applying the processing of the flowchart in FIG. 13 to the hierarchical metadata in FIG. 4A.

FIG. 14C illustrates an exemplary image of hierarchical metadata of a firstly divided print document resulting from applying the processing of the flowchart in FIG. 13 to the hierarchical metadata in FIG. 4A.

### DESCRIPTION OF THE EMBODIMENTS

Various exemplary embodiments, features, and aspects of the invention will be described in detail below with reference to the drawings. One disclosed feature of the embodiments may be described as a process which is usually depicted as a flowchart, a flow diagram, a timing diagram, a structure diagram, or a block diagram. Although a flowchart or a timing diagram may describe the operations or events as a sequential process, the operations may be performed, or the events may occur, in parallel or concurrently. In addition, the order of the operations or events may be re-arranged. A process is terminated when its operations are completed. A process may correspond to a method, a program, a procedure, a method of manufacturing or fabrication, a sequence of operations performed by an apparatus, a machine, or a logic circuit, etc.

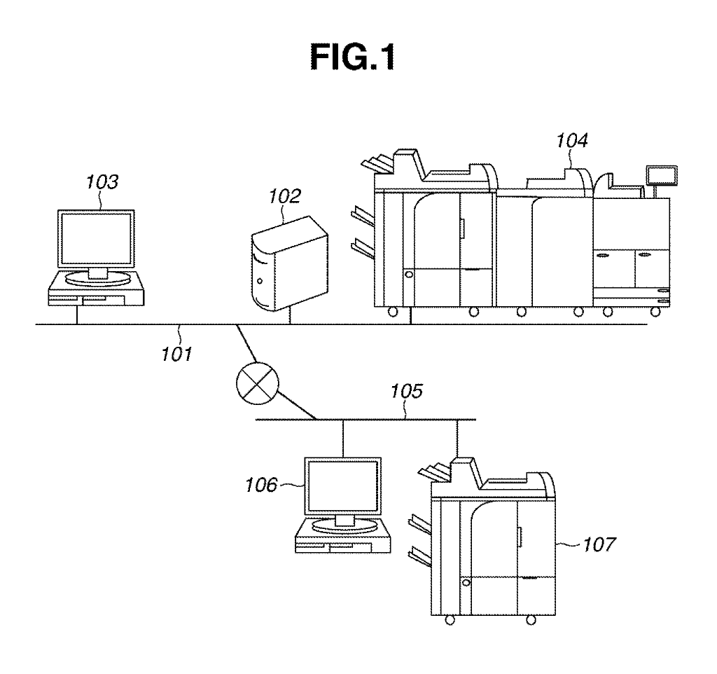

FIG. 1 schematically illustrates a configuration of a POD system including a printing system according to a first exemplary embodiment.

This POD system includes a server computer 102, a client computer 103, and a printing apparatus 104, which are connected via a network 101.

The server computer 102 manages data transmission and reception with various apparatuses connected to the network 101. The client computer 103 is capable of editing a print document and transmitting the print document to the printing apparatus 104 and the server computer 102 via the network 101. Upon reception of the print document, the printing apparatus 104 communicates with the server computer 102 to start printing as required.

The print document generated by the client computer 103 may be transmitted via the network 101 to another client computer 106 managed under a network environment 105, which is different from the server computer 102. Then, after being edited by the client computer 106, the print document may also be printed by the printer apparatus 107 in another environment.

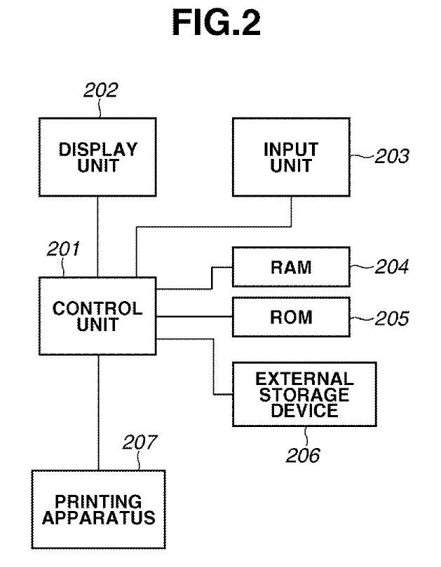

FIG. 2 is a block diagram illustrating an exemplary hardware configuration of the client computers 103 and 106, which are exemplary information processing apparatuses.

The control unit 201 is a central processing unit (CPU), which controls a display unit 202 and an input unit 203. The display unit 202 is a cathode ray tube (CRT) or a liquid crystal display monitor. The input unit 203 corresponds to a pointing device such as a keyboard and a mouse. A random access memory (RAM) 204 is a nonvolatile mass-storage memory for storing various program codes and data files loaded from a read-only memory (ROM) 205. The ROM 205 stores computer programs to be executed by the control unit 201. An external storage device 206 includes a hard disk and a drive unit for writing data to the hard disk. The external storage device 206 is capable of exchanging data with another hard disk via a network, and stores data required for printing.

Although, in the present exemplary embodiment, a program is loaded onto the RAM 204, it may also be executed directly from the ROM 205. Although each piece of data to be processed exists on the RAM 204, all pieces of data may be arranged on the external storage device 206 and may also be loaded from the external storage device 206 onto the RAM 204 as required. Further, data may also be arranged on a cache memory of the control unit 201.

Processing according to a functional configuration and flowcharts (described below) is implemented when the control unit 201 executes relevant processing based on a program.

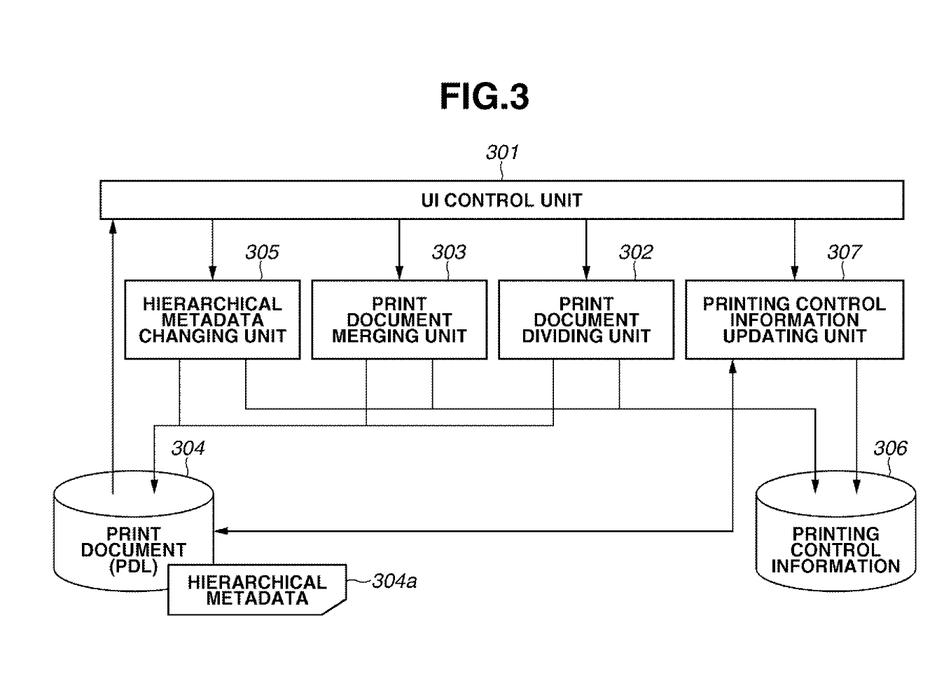

FIG. 3 illustrates an exemplary functional configuration of the client computers 103 and 106, which are exemplary information processing apparatuses.

A UI control unit 301 handles data input via the input unit 203 in FIG. 2. The UI control unit 301 enables the user to instruct each processing unit to input data. The UI control unit 301 loads a print document (PDL) 304 from the external storage device 206 in FIG. 2, and then displays it on the display unit 202 in FIG. 2. The UI control unit 301 is an exemplary receiving unit.

In response to an instruction from the UI control unit 301, a print document dividing unit 302 divides the print document 304.

In response to an instruction from the UI control unit 301, a print document merging unit 303 merges a plurality of print documents 304.

The print document 304, which is a data portion handled in the present exemplary embodiment, exists in the external storage device 206 in FIG. 2.

Hierarchical metadata 304a is metadata accompanying the print document 304.

In response to an instruction from the UI control unit 301, a hierarchical metadata changing unit 305 changes the hierarchical metadata 304a.

Printing control information 306, which is associated with a print document, exists in the external storage device 206 in FIG. 2. The printing apparatus 104 in FIG. 1 prints data according to the printing control information 306.

A printing control information updating unit 307 updates the printing control information 306 and the hierarchical metadata 304a.

Pieces of processing of flowcharts described below are not limited to examples but may be combined, merged, or divided in any way as long as the result of the embodiments is satisfied. Each of these processes functions as a single functional element, and may be used in combination with other processes.

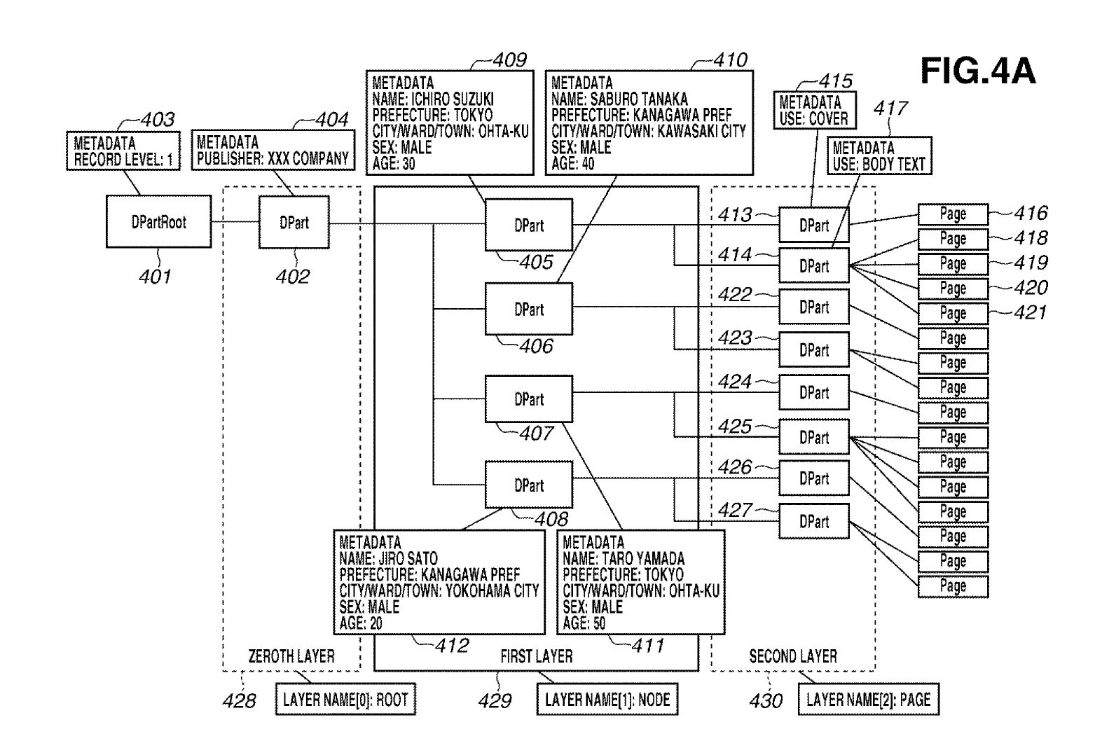

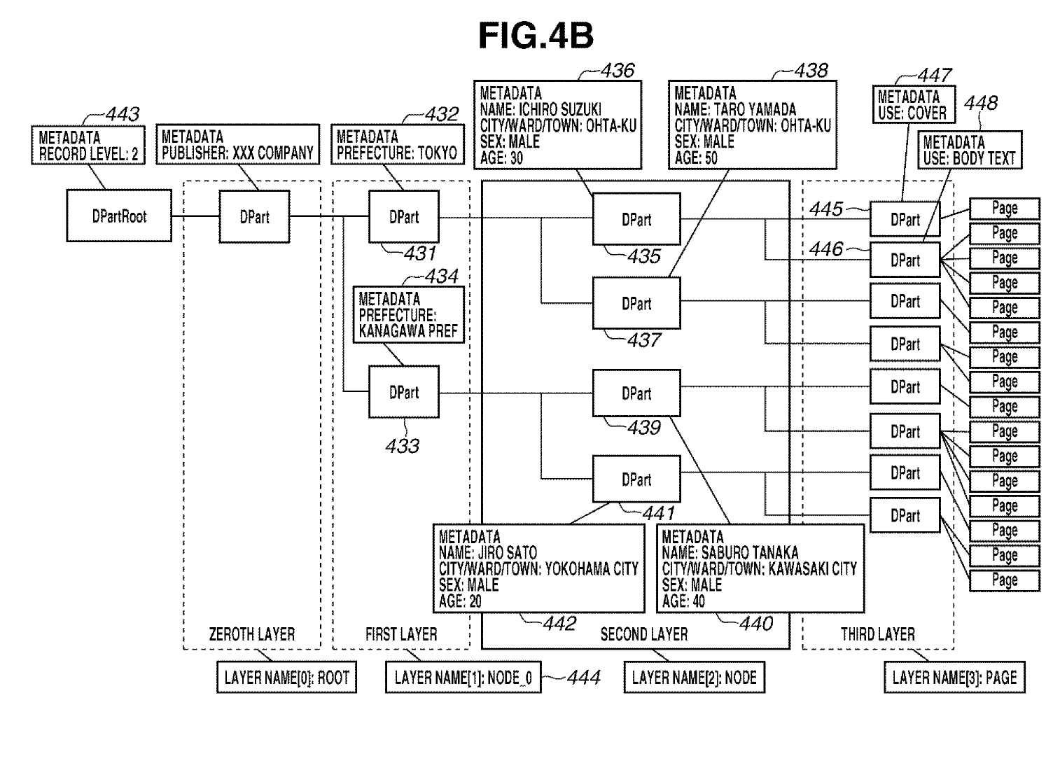

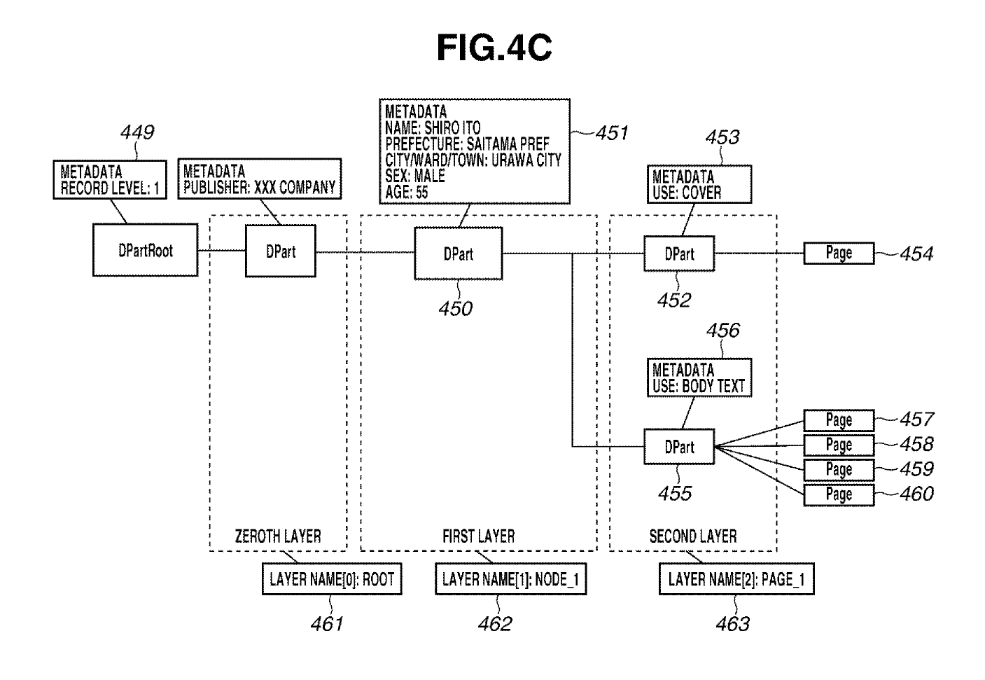

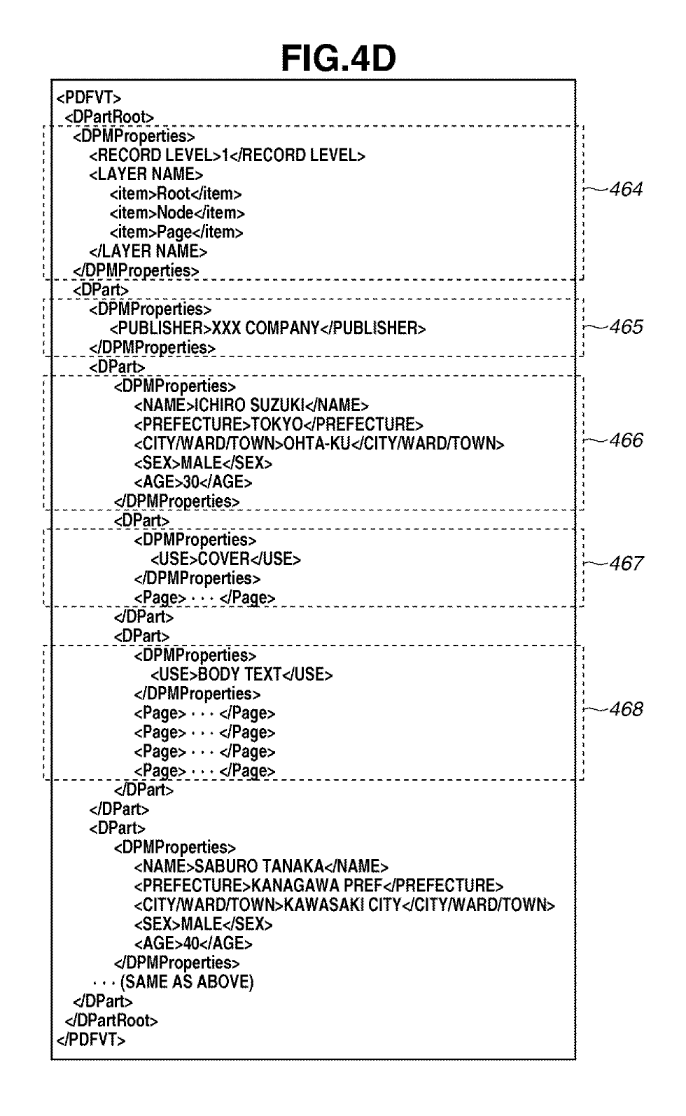

FIG. 4A illustrates an exemplary image of the hierarchical metadata 304a in FIG. 3.

A DPartRoot 401 is called a Document Part Root (DPartRoot), which serves as a parent node (root node) having a data structure for managing hierarchical metadata. Under the DPartRoot 401, a Document Part (DPart) 402 is linked as a child node to forma hierarchical structure. Although each DPartRoot and DPart may have any metadata, only some pieces of metadata will be described to simplify the explanation.

Metadata 403 is metadata of the DPartRoot 401, having a key “RECORD LEVEL” and a value “1”. The key “RECORD LEVEL” is a number starting from 0, which indicates a layer to be repetitively processed. More specifically, the value “1” means that the first layer is a layer to be repetitively processed.

Metadata 404 is metadata of the DPart 402, having a key “PUBLISHER” and a value “XXX COMPANY.”

The DPart 402 has DParts 405, 406, 407, and 408 as child nodes.

Metadata 409 is metadata of the DPart 405, having a key “NAME” and a value “SUZUKI ICHIRO”, a key “PREFECTURE” and a value “TOKYO”, a key “CITY/WARD/TOWN” and a value “OHTA-KU”, a key “SEX” and a value “MALE”, and a key “AGE” and a value “30.”

Metadata 410 is metadata of the DPart 406, having a key “NAME” and a value “SABURO TANAKA”, a key “PREFECTURE” and a value “KANAGAWA PREF”, a key “CITY/WARD/TOWN” and a value “KAWASAKI CITY”, a key “SEX” and a value “MALE”, and a key “AGE” and a value “40.”

Metadata 411 is metadata of the DPart 407, having a key “NAME” and a value “TARO YAMADA”, a key “PREFECTURE” and a value “TOKYO”, a key “CITY/WARD/TOWN” and a value “OHTA-KU”, a key “SEX” and a value “MALE”, and a key “AGE” and a value “50.”

Metadata 412 is metadata of the DPart 408, having a key “NAME” and a value “JIRO SATO”, a key “PREFECTURE” and a value “KANAGAWA PREF”, a key “CITY/WARD/TOWN” and a value “YOKOHAMA CITY”, a key “SEX” and a value “MALE”, and a key “AGE” and a value “20.”

The DPart 405 has DParts 413 and 414 as child nodes.

The DPart 413 has metadata 415 having a key “USE” and a value “COVER.” The DPart 413 further has a reference to a Page object 416 as a cover page.

The DPart 414 has metadata 417 having a key “USE” and a value “BODY TEXT.” The DPart 414 further has a reference to Page objects 418, 419, 420, and 421 as body text pages.

The DPart 406 has DParts 422 and 423 as child nodes.

Similar to the DPart 413, the DPart 422 has a reference to metadata having a key “USE” and a value “COVER”, and to a Page object. Similar to the DPart 414, the DPart 423 has a reference to metadata having a key “USE” and a value “BODY TEXT”, and to Page objects.

The DPart 407 has DParts 424 and 425 as child nodes.

Similar to the DPart 413, the DPart 424 has a reference to metadata having a key “USE” and a value “COVER”, and to a Page object. Similar to the DPart 414, the DPart 425 has a reference to metadata having a key “USE” and a value “BODY TEXT”, and to Page objects.

The DPart 408 has DParts 426 and 427 as child nodes.

Similar to the DPart 413, the DPart 426 has a reference to metadata having a key “USE” and a value “COVER”, and to a Page object. Similar to the DPart 414, the DPart 427 has a reference to metadata having a key “USE” and a value “BODY TEXT”, and to Page objects.

Metadata 428 is metadata of the DPartRoot 401, having a key “LAYER NAME” and a value “Root.” Values for the key “LAYER NAME” are stored in an array form, and “Root” is the zeroth element value. With the metadata 428, the DPart 402 immediately following the DPartRoot 401 belongs to the zeroth layer.

Metadata 429 is metadata of the DPartRoot 401, having a key “LAYER NAME” and the first element value “Node.” With the metadata 429, the DParts 405, 406, 407, and 408 belong to the first layer.

Metadata 430 is metadata of the DPartRoot 401, having a key “LAYER NAME” and the second element value “Page.” With the metadata 430, the DParts 413, 414, 422, 423, 424, 425, 426, and 427 belong to the second layer.

As mentioned above, the hierarchical metadata 304a holds metadata with a hierarchical data structure called a DPart. Each DPart may be represented in the XML format based on the metadata key “LAYER NAME” of the DPartRoot 401. For example, referring to FIG. 4A, the second layer is represented as “/Root/Node/Page.”

FIG. 4B illustrates an exemplary image of the hierarchical metadata 304a in FIG. 4A after editing. More specifically, for metadata of each of the DParts 405, 406, 407, and 408 in the first layer in FIG. 4A, DParts having a certain specific key are extracted and grouped to increase the number of layers.

A DPart 431 is a new document part defined as a result of grouping by the key “PREFECTURE” applied to the DParts 405 and 407 having the metadata 409 and 411 having a key “PREFECTURE” and a value “TOKYO” in FIG. 4A.

Metadata 432 is metadata having a key “PREFECTURE” and a value “TOKYO” obtained as a result of grouping the DPart 431.

A DPart 433 is a new document part defined as a result of grouping by the key “PREFECTURE” applied to the DParts 406 and 408 having the metadata 410 and 412 having a key “PREFECTURE” and a value “KANAGAWA PREF” in FIG. 4A.

Metadata 434 is metadata having a key “PREFECTURE” and a value “KANAGAWA PREF” obtained as a result of grouping the DPart 433.

The DPart 431 has a DPart 435 as a child node and metadata 436, and a DPart 437 as a child node and metadata 438.

The DPart 433 has a DPart 439 as a child node and metadata 440, and a DPart 441 as a child node and metadata 442.

Metadata 443 is metadata of the DPartRoot, having a key “RECORD LEVEL” and a value “2” since the layer to be repetitively processed is changed because of the increased number of layers.

Metadata 444 has a key “LAYER NAME” and a value “Node_0” corresponding to the first layer.

A DPart 445 is DPart of a child node of the DPart 435, and has a reference to metadata 447 and a Page object.

A DPart 446 is DPart of a child node of the DPart 435, and has a reference to metadata 448 and Page objects.

As in the case where the metadata in FIG. 4A is edited to the metadata in FIG. 4B, increasing the number of layers by using a specific key is referred to as “grouping” the hierarchical metadata 304a. On the contrary, as in the case where the metadata in FIG. 4B is edited to the metadata in FIG. 4A, decreasing the number of layers is referred to as “canceling grouping of” the hierarchical metadata 304a. Such change operations are applied to the hierarchical metadata 304a via the hierarchical metadata changing unit 305.

Increasing the number of layers of hierarchical metadata is equivalent to increasing the number of layers of print documents having the same hierarchical structure to which the hierarchical metadata is attached. Likewise, decreasing the number of layers of hierarchical metadata is equivalent to decreasing the number of layers of print documents having the same hierarchical structure to which the hierarchical metadata is attached.

FIG. 4C illustrates an exemplary image of the hierarchical metadata 304a in FIG. 3, different from the one in FIG. 4A.

Metadata 449 is metadata having a key “RECORD LEVEL” and a value “1”.

A DPart 450 has metadata 451 having a key “NAME” and a value “SHIRO ITO”, a key “PREFECTURE” and a value “SAITAMA PREF”, a key “CITY/WARD/TOWN” and a value “URAWA CITY”, a key “SEX” and a value “MALE”, and a key “AGE” and a value “55.”

A DPart 452 has a reference to metadata 453 having a key “USE” and a value “COVER”, and to a Page object 454.

A DPart 455 has a reference to metadata 456 having a key “USE” and a value “BODY TEXT”, and to Page objects 457, 458, 459, and 460.

Metadata 461, 462, and 463 are metadata of the DPartRoot, having a key “LAYER NAME” and values “Root” (zeroth element), “Node_1” (first element), and “Page_1” (second element), respectively.

FIG. 4D illustrates an exemplary image of the hierarchical metadata 304a in FIG. 4A, represented in the XML format.

Metadata 464 is the XML representation of the metadata 403 of the DPartRoot 401 in FIG. 4A. With the metadata 464, keys “RECORD LEVEL” and “LAYER NAME” are represented in the XML format.

Metadata 465 is the XML representation of the metadata 404 of the DPart 402 in FIG. 4A. With the metadata 465, a key “PUBLISHER” is represented in the XML format.

Metadata 466 is the XML representation of the metadata 409 of the DPart 405 in FIG. 4A. With the metadata 466, keys “NAME”, “PREFECTURE”, “CITY/WARD/TOWN”, “SEX”, and “AGE” are represented in the XML format.

Metadata 467 is the XML representation of a reference to the metadata 415 of the DPart 413 and the Page object in FIG. 4A. With the metadata 467, a key “USE” is represented in the XML format.

Metadata 468 is the XML representation of a reference to the metadata 417 of the DPart 414 and the Page objects in FIG. 4A. With the metadata 468, a key “USE” is represented in the XML format.

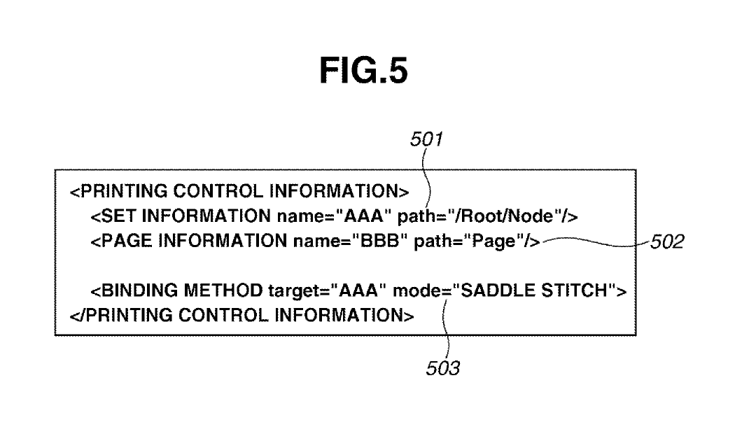

FIG. 5 illustrates an exemplary image of the printing control information 306 in FIG. 3 in the hierarchical metadata 304a in FIG. 4A.

SET information 501 indicates which layer is a unit of repetitive processing, and is referred to through XPath by using the XML representation of the DPart. Therefore, the layer for “RECORD LEVEL” will be described in the SET information 501. Referring to FIG. 4A, since the metadata key “RECORD LEVEL” is “1”, the first layer is described in the SET information 501. Referring to FIG. 5, the printing control information 306 defines “/Root/Node” and “AAA” as an alias. “/Root/Node” is the XML representation of the first layer which is a layer of the hierarchical metadata 304a, to be repetitively processed. Although the printing control information 306 defines a reference to the print document 304 based on the metadata key “LAYER NAME”, this representation also applies to a reference thereto based on the metadata key “RECORD LEVEL.”

PAGE information 502 indicates which layer has a reference to a Page object. FIG. 5 illustrates that the layer of Page under Node under Root in the hierarchical metadata 304a has a reference to a Page object, and “BBB” is defined as an alias. Although the PAGE information indicates a layer by using a relative path based on the SET information, this representation also applies to case where an absolute path is used like the SET information.

Binding method information 503 is one piece of the printing control information 306. Referring to FIG. 5, the binding method information 503 specifies saddle stitch for the alias “AAA” based in the printing control information 306. The alias “AAA” acquires information from the hierarchical metadata 304a via the SET information 501. This enables such control that the print document 304 is printed with saddle stitch in a layer “/Root/Node”, which is the unit specified by the SET information 501.

The control unit 201 in FIG. 2 may instruct the printing apparatus 104 in FIG. 1 for printing by using the SET information 501 (unit of repetitive processing) and the PAGE information 502 in the printing control information 306. The printing control information 306 is to be considered as an example, and is similarly usable for JDF and other job tickets and print tickets.

When grouping is applied to the hierarchical metadata 304a in FIG. 4A to obtain the metadata in FIG. 4B or canceling grouping in response to an instruction from the UI control unit 301, the position of the layer to be repetitively processed is changed. In this case, the printing control information updating unit 307 in FIG. 3 updates the SET information 501 and the PAGE information 502 so that a print instruction is correctly issued. For example, when the metadata in FIG. 4A is changed to the metadata in FIG. 4B, the SET information 501 becomes [path=“/Root/Node_0/Node”].

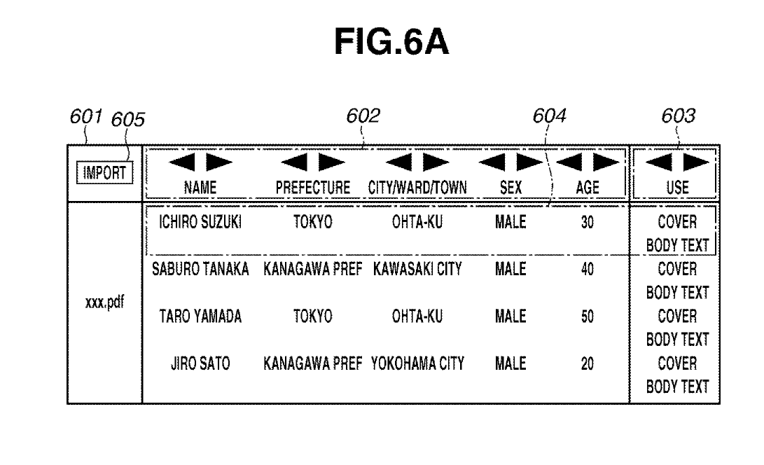

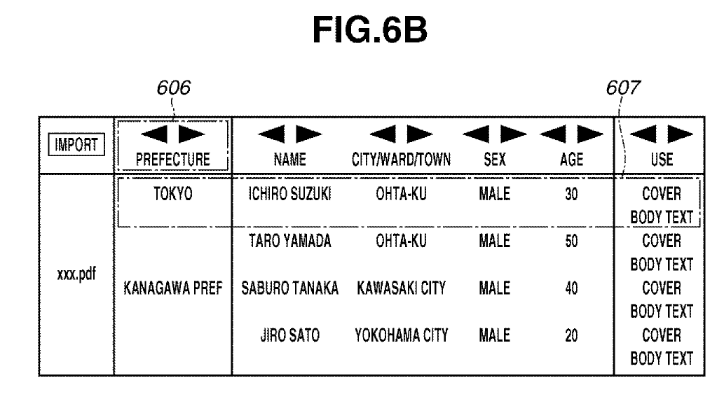

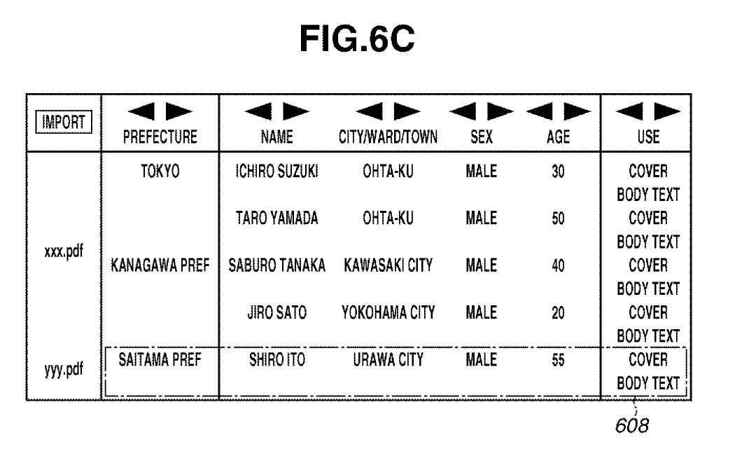

FIG. 6A illustrates an exemplary image of the hierarchical metadata change screen of the UI control unit 301, displaying the hierarchical metadata 304a in FIG. 4A. To simplify explanation, FIG. 6A illustrates only the first and second layers of the hierarchical metadata 304a in FIG. 4A.

FIG. 6A illustrates a hierarchical metadata change screen 601.

A field 602 indicates that the metadata keys “NAME”, “PREFECTURE”, “CITY/WARD/TOWN”, “SEX”, and “AGE” exist in the first layer. The field 602 includes grouping and grouping canceling buttons for each key. Pressing these keys performs grouping and cancels grouping.

A field 603 indicates that a metadata key “USE” exists in the second layer.

A field 604 indicates values of respective keys for the DParts 405, 413, and 414 in FIG. 4A, for example, a value “SUZUKI ICHIRO” is mapped for the key “NAME.” Likewise, a value “TOKYO” exists for the key “PREFECTURE”, a value “OHTA-KU” exists for the key “CITY/WARD/TOWN”, a value “MALE” exists for the key “SEX”, and a value “30” exists for the key “AGE.” The field 604 also indicates that, in the second layer, values “COVER” and “BODY TEXT” exist for the key “USE.”

When the user presses an IMPORT button 605 to select the print documents 304, the plurality of print documents 304 may be simultaneously displayed. In this case, only xxx.pdf is imported.

FIG. 6B illustrates an exemplary image of the hierarchical metadata change screen as a result of applying grouping by the key “PREFECTURE” to the hierarchical structure illustrated in FIG. 6A. When grouping by the key “PREFECTURE” is applied to the hierarchical structure illustrated in FIG. 6A, it changes to the one in FIG. 6B.

Similar to the field 602, a field 606 indicates that a metadata key “PREFECTURE” exists in the first layer. Grouping and grouping canceling buttons are provided for each key.

Similar to the field 604, a field 607 indicates values of the keys for the DParts 431, 435, 445 and 446 in FIG. 4B, and a value “TOKYO” exists for the key “PREFECTURE.” In the second layer, a value “SUZUKI ICHIRO” exists for the key “NAME”, a value “OHTA-KU” exists for the key “CITY/WARD/TOWN”, a value “MALE” exists for the key “SEX”, and a value “30” exists for the key “AGE.” In the third layer, values “COVER” and “BODY TEXT” exist for the key “USE.”

FIG. 6C illustrates an exemplary image of the hierarchical metadata change screen as a result of importing another print document 304 into the hierarchical structure illustrated in FIG. 6B by pressing the IMPORT button 605. More specifically, the metadata in FIG. 4C is imported.

A field 608 indicates a result of importing a print document 304 which is different from the existing print document 304, i.e., values of the keys for the DParts 450, 452, and 455 in FIG. 4C. More specifically, since metadata key “PREFECTURE” exists in the first layer, grouping by the key “PREFECTURE” is applied to the DPart 450. As a result, a value “SAITAMA PREF” exists for the key “PREFECTURE” in the first layer. In the second layer, a value “SHIRO ITO” exists for the key “NAME”, a value “URAWA CITY” exists for the key “CITY/WARD/TOWN”, a value “MALE” exists for the key “SEX”, and a value “55” exists for the key “AGE.” In the third layer, values “COVER” and “BODY TEXT” exist for the key “USE.”

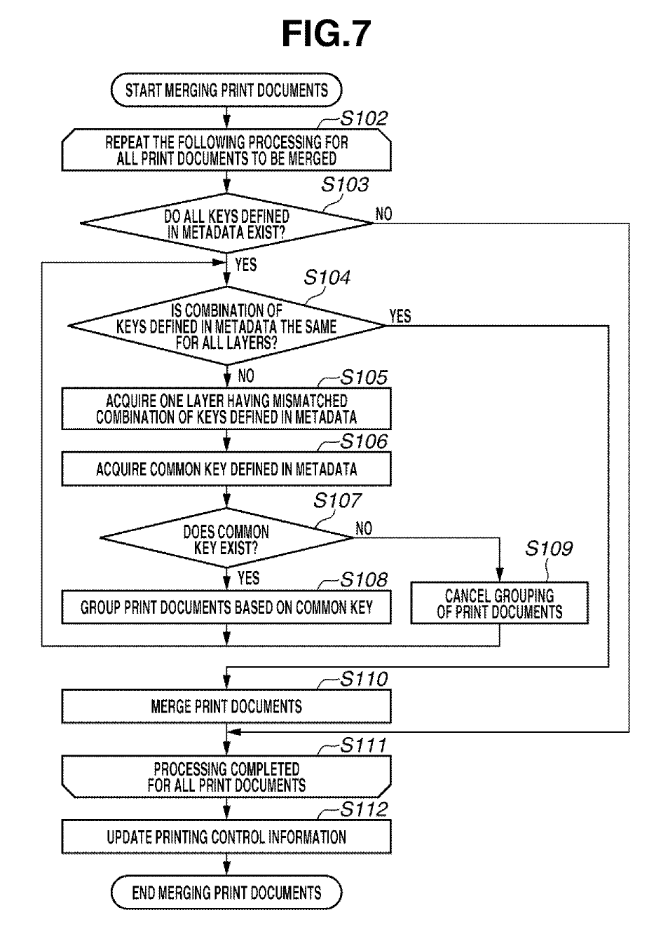

FIG. 7 is a flowchart illustrating processing performed by the print document merging unit 303 to merge the plurality of print documents 304 to be merged. When the user issues an instruction for merging the print documents 304 and displaying the result on the hierarchical metadata change screen 601 in FIG. 6, in operations S102 through S111, the print document merging unit 303 repeats processing of operations S103 to S110 for all of the print documents to be merged.

In operation S103, the print document merging unit 303 determines whether all of the metadata keys defined in the hierarchical metadata 304a exist. When the print document merging unit 303 determines that all of the defined metadata keys exist (YES in operation S103), the processing proceeds to operation S104. When the print document merging unit 303 determines that an undefined key exists (NO in operation S103), the processing proceeds to operation S111 to skip the merge processing. When the merge processing is skipped, the print document merging unit 303 may notify the user of print documents 304 not having been merged.

In operation S104, the print document merging unit 303 determines whether the combination of keys defined in the metadata of DParts is the same for all layers. When the number of layers is mismatched, the print document merging unit 303 determines that the combination of keys is mismatched. When the print document merging unit 303 determines that the combination of keys is the same for all layer (YES in operation S104), the processing proceeds to operation S110. When the print document merging unit 303 determines that the combination of keys is mismatched (NO in operation S104), the processing proceeds to operation S105. For example, with the hierarchical metadata 304a in FIGS. 4B and 4C, the print document merging unit 303 does not determine that the combination of keys is the same for all layers.

In operation S105, the print document merging unit 303 searches for a layer having a mismatched combination of metadata keys from the first layer, and then acquires one layer having a mismatched combination of keys. For example, with the hierarchical metadata 304a in FIGS. 4B and 4C, the first layer will be acquired.

In operation S106, the print document merging unit 303 acquires a common key defined in metadata in the layer acquired in operation S105. For example, when the first layer of the hierarchical metadata 304a in FIGS. 4B and 4C is to be processed, the key “PREFECTURE” is acquired as a common key.

In operation S107, the print document merging unit 303 determines whether the common key acquired in operation S106 exists. When the print document merging unit 303 determines that the common key exists (YES in operation S107), the processing proceeds to operation S108. When the print document merging unit 303 determines that no common key exists (NO in operation S107), the processing proceeds to operation S109. For example, when the first layer of the hierarchical metadata 304a in FIGS. 4B and 4C is to be processed, a common key “PREFECTURE” exists and, therefore, the processing proceeds to operation S108.

In operation S108, the print document merging unit 303 applies grouping to the print documents 304 for each of the layers to be processed, based on the common key, and the processing proceeds to operation S104. For example, when the first layer of the hierarchical metadata 304a in FIGS. 4B and 4C is to be processed, grouping has already been applied to the metadata in FIG. 4B based on the common key “PREFECTURE” and, therefore, the print document merging unit 303 performs no operation. On the other hand, the print document merging unit 303 applies grouping to the hierarchical metadata 304a in FIG. 4C based on the common key “PREFECTURE.” As a result, a layer having a key “PREFECTURE” is generated in the first layer of the hierarchical metadata 304a in FIG. 4C. Then, the processing returns the processing to operation S104. In operation S104, the print document merging unit 303 determines whether the combination of keys is the same for all layers. When grouping by the key “PREFECTURE” is applied to the hierarchical metadata 304a in FIGS. 4B and 4C, the combination of keys is the same for all layers (YES in operation S104), and the processing proceeds to operation S110.

In operation S109, the print document merging unit 303 cancels grouping in layers of the print documents 304 in which no common key exists, and the processing proceeds to operation S104.

In operation S110, when the combination of metadata keys is the same for all layers, the print document merging unit 303 merges the print documents 304. Merge processing for the hierarchical metadata 304a is equivalent to respectively linking child and parent nodes of DParts.

In operation S111, when the print document merging unit 303 completes the processing of operations S103 to S110 for all of the print documents 304, the processing proceeds to operation S112.

In operation S112, the printing control information updating unit 307 updates the printing control information 306, and updates the key “RECORD LEVEL” of the hierarchical metadata 304a, and then the processing ends. Of course, if the printing control information 306 becomes no longer necessary, the printing control information updating unit 307 deletes the printing control information 306. For example, in the case of the metadata in FIGS. 4B and 4C, the key “RECORD LEVEL” is “2”, and the SET information 501 of the printing control information 306 becomes [path=“/Root/Node_0/Node”].

Although, in this case, the printing control information updating unit 307 merges and displays the metadata at the timing of importing and, at the same time, updates the print document 304 and the printing control information 306, the printing control information updating unit 307 may update the printing control information 306 at a different timing from the timing of importing, with a different operation method.

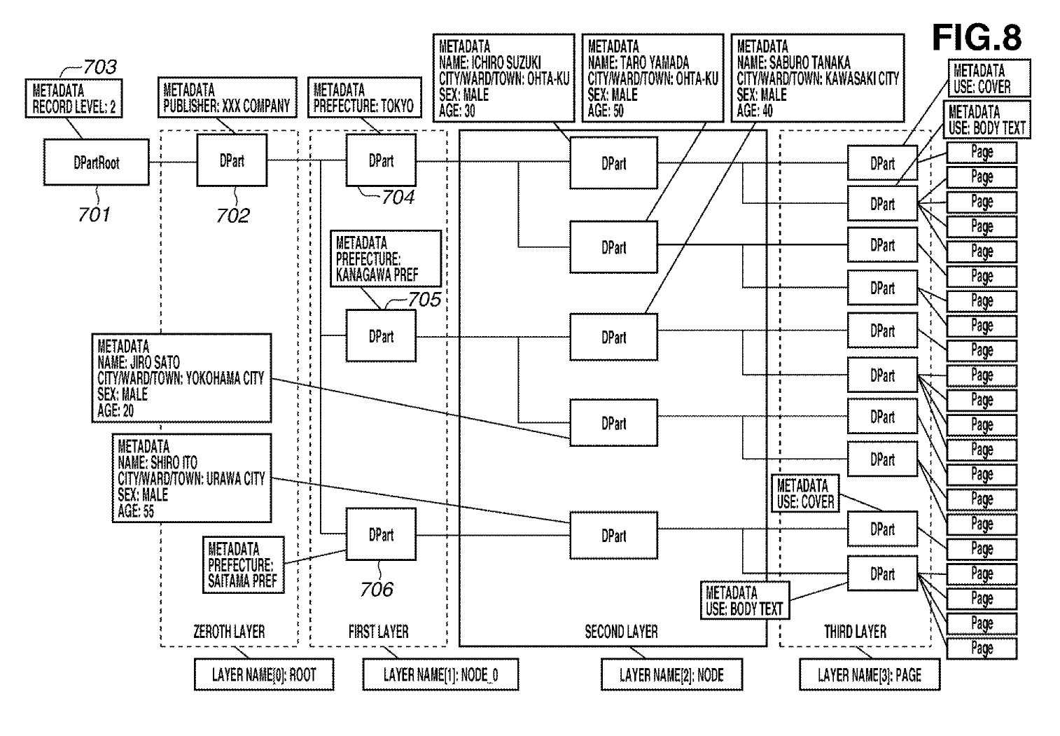

FIG. 8 illustrates an exemplary image of merged hierarchical metadata 304a resulting from applying the processing of the flowchart in FIG. 7 to the hierarchical metadata in FIGS. 4B and 4C.

A DPartRoot 701 is a DPartRoot after merging. Under the DPartRoot 701, a DPart 702 is linked as a child node to form a hierarchical structure. After the metadata in FIGS. 4B and 4C are merged, metadata 703 has a key “RECORD LEVEL” and a value “2”. After the metadata in FIGS. 4B and 4C are merged, the DPart 702 has DParts 704, 705, and 706 as child nodes.

As mentioned above, the present exemplary embodiment enables merging the hierarchical metadata 304a, i.e., the plurality of print documents 304 by importing the plurality of print documents 304. Further, the present exemplary embodiment updates at the same time the printing control information 306 referring to the hierarchical metadata, ensuring the overall consistency even after merging. Further, the present exemplary embodiment provides a simple method for editing (merging) the hierarchical metadata 304a (and print documents).

The first exemplary embodiment has specifically been described based on a method for importing and merging the plurality of print documents 304 by finding a combination of common keys defined in the hierarchical metadata 304a. However, it is necessary to consider a method for merging metadata even with a mismatched combination of keys of the hierarchical metadata 304a.

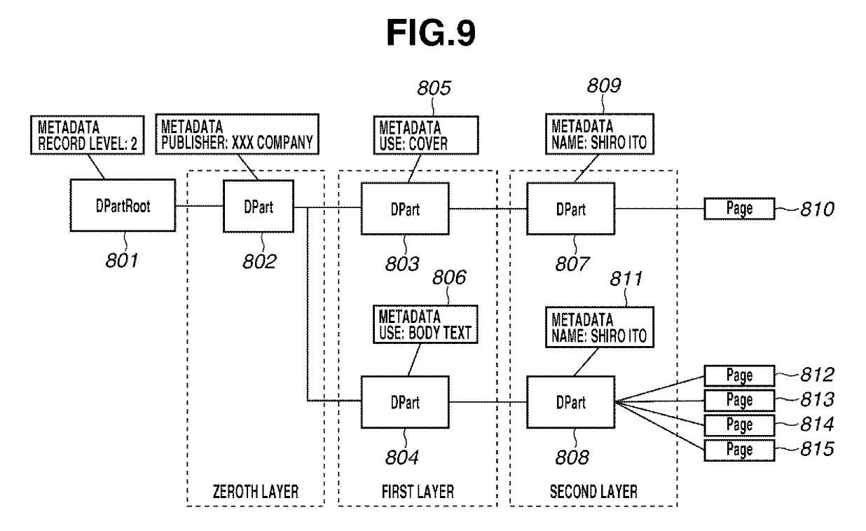

FIG. 9 illustrates an exemplary image of the hierarchical metadata 304a in a certain print document 304.

A DPartRoot 801 has a DPart 802 as a child node.

The DPart 802 has DParts 803 and 804 as child nodes. The DPart 803 has metadata 805 having a key “USE” and a value “COVER.” The DPart 803 has a DPart 807 as a child node.

The DPart 804 has metadata 806 having a key “USE” and a value “BODY TEXT.” The DPart 804 has a DPart 808 as a child node.

The DPart 807 has a reference to metadata 809 having a key “NAME” and a value “SHIRO ITO”, and to a Page object 810.

The DPart 808 has a reference to metadata 811 having a key “NAME” and a value “SHIRO ITO”, and to the Page objects 812, 813, 814, and 815.

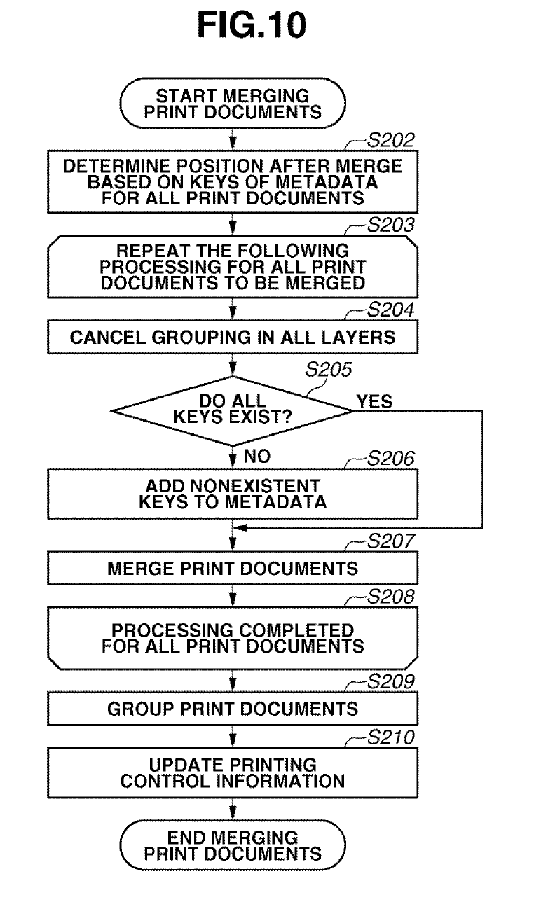

When merging the hierarchical metadata 304a in FIG. 9 and the hierarchical metadata 304a in FIG. 4A, the method described in the first exemplary embodiment skips the merge processing because the combination of keys defined in the metadata is mismatched. Accordingly, in the second exemplary embodiment, a method for merging metadata even with a mismatched combination of keys will be described below with a reference to FIG. 10.

FIG. 10 is a flowchart illustrating processing performed by the print document merging unit 303 according to the second exemplary embodiment to merge a plurality of print documents 304. When the user issues an instruction for merging the print documents 304 on the hierarchical metadata change screen 601 in FIG. 6, in operation S202, the print document merging unit 303 acquires metadata keys currently being used by all of the print documents 304 and then determines a position after merging. For example, in the case of the hierarchical metadata 304a in FIGS. 9 and 4A, the print document merging unit 303 determines that a key “USE” exists in the first layer and other keys in the second layer. As a result, the second layer has a combination of keys “NAME”, “PREFECTURE”, “CITY/WARD/TOWN”, “SEX”, and “AGE.”

In operations S203 through S208, the print document merging unit 303 repeats the processing of operations S204 to S207 for all of the print documents 304 to be merged.

In operation S204, the print document merging unit 303 cancels grouping for all layers. As a result, the DParts of the first layer in FIG. 9 have a reference to metadata having keys “USE” and “NAME”, and to Page objects. Likewise, the DParts of the first layer in FIG. 4A have a reference to metadata having keys “USE”, “NAME”, “PREFECTURE”, “CITY/WARD/TOWN”, “SEX”, and “AGE”, and to Page objects.

In operation S205, the print document merging unit 303 determines whether all of the keys acquired in operation S202 exist. When the print document merging unit 303 determines that all of the keys exist (YES in operation S205), the processing proceeds to operation S207. When the print document merging unit 303 does not determine that all of the keys exist (NO in operation S205), the processing proceeds to operation S206. In the case of the metadata in FIG. 9, the keys “PREFECTURE”, “CITY/WARD/TOWN”, “SEX”, and “AGE” do not exist, and the processing proceeds to operation S206.

In operation S206, the print document merging unit 303 adds nonexistent keys to the metadata. A value of the key may be a predetermined default value or a blank. In the case of the metadata in FIG. 9, the keys “PREFECTURE”, “CITY/WARD/TOWN”, “SEX”, and “AGE” are attached to the hierarchical metadata 304a.

In operation S207, the print document merging unit 303 merges the print documents 304. Referring to FIGS. 9 and 4A, the first layer with which grouping is canceled is linked with the DPart of the zeroth layer.

In operation S208, the print document merging unit 303 performs the processing of operations S204 to S207 for all of the print documents 304, and the processing proceeds to operation S209.

In operation S209, the print document merging unit 303 performs grouping to achieve the hierarchical structure determined in operation S202. For example, the print document merging unit 303 performs grouping by the key “USE” so that a key “USE” exists in the first layer and other keys in the second layer.

In operation S210, the printing control information updating unit 307 updates the printing control information 306 and updates the key “RECORD LEVEL” of the hierarchical metadata 304a, and then this sequence ends. Of course, if the printing control information 306 becomes no longer necessary, the printing control information updating unit 307 deletes the printing control information 306. For example, in the case of the metadata in FIGS. 9 and 4A, the key “RECORD LEVEL” is “2”. After grouping in operation S209, when the layer name of a new first layer is “Node_0” and the layer name of the second layer is “Node”, the SET information 501 in the printing control information 306 becomes [path=“/Root/Node_0/Node”]. Although, in this case, the printing control information updating unit 307 updates the print document 304 and the printing control information 306 at the same time as the merge and display processing at the timing of importing, the printing control information updating unit 307 may update the printing control information 306 at a different timing from the timing of importing, with a different operation method.

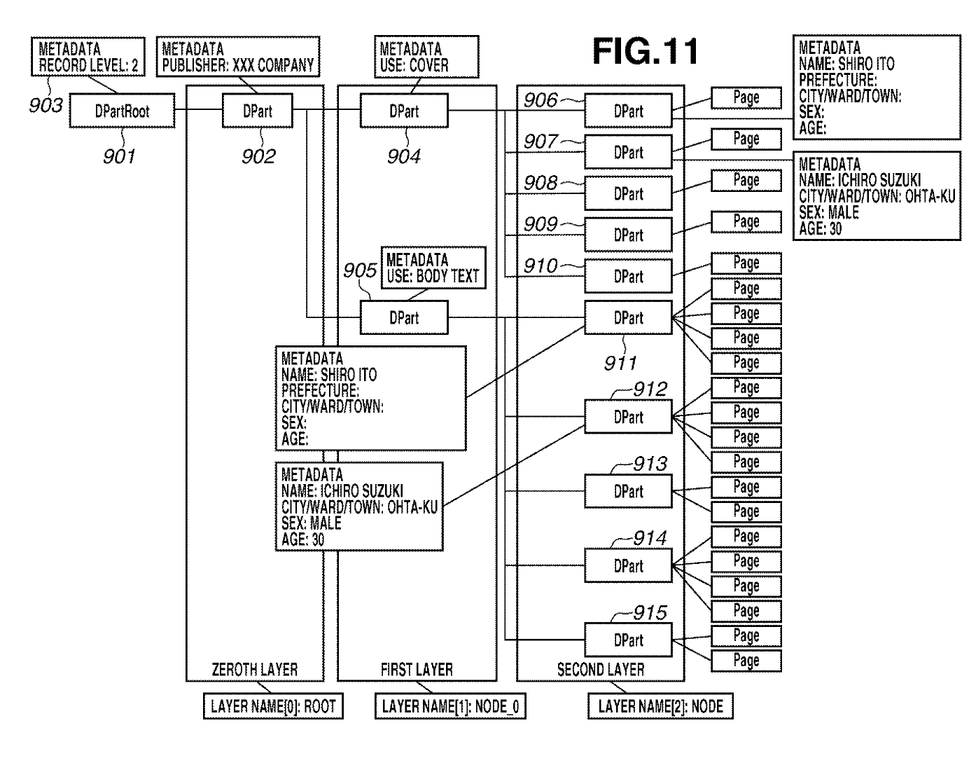

FIG. 11 illustrates an exemplary image of merged hierarchical metadata 304a resulting from applying the processing of the flowchart in FIG. 10 to the hierarchical metadata in FIGS. 9 and 4A.

A DPartRoot 901 is a DPartRoot after merging. Under the DPartRoot 901, a DPart 902 is linked with child nodes to form a hierarchical structure. After the print documents in FIGS. 9 and 4A are merged, metadata 903 has a key “RECORD LEVEL” and a value “2”. The DPart 902 has DParts 904 and 905 as child nodes. The DPart 904 has DParts 906, 907, 908, 909, and 910 as child nodes. The DPart 905 has DParts 911, 912, 913, 914, and 915 as child nodes.

As mentioned above, the present exemplary embodiment enables importing and merging a plurality of print documents 304 even with a mismatched combination of keys of the hierarchical metadata 304a. At the same time, the present exemplary embodiment updates the printing control information 306 referring to the hierarchical metadata 304a, ensuring the overall consistency even after merging. Further, the present exemplary embodiment provides a simple method for editing the hierarchical metadata 304a.

The first and second exemplary embodiments have specifically been described based on a method for importing and merging a plurality of print documents 304. In a third exemplary embodiment, a method for dividing the print document 304 will be described below.

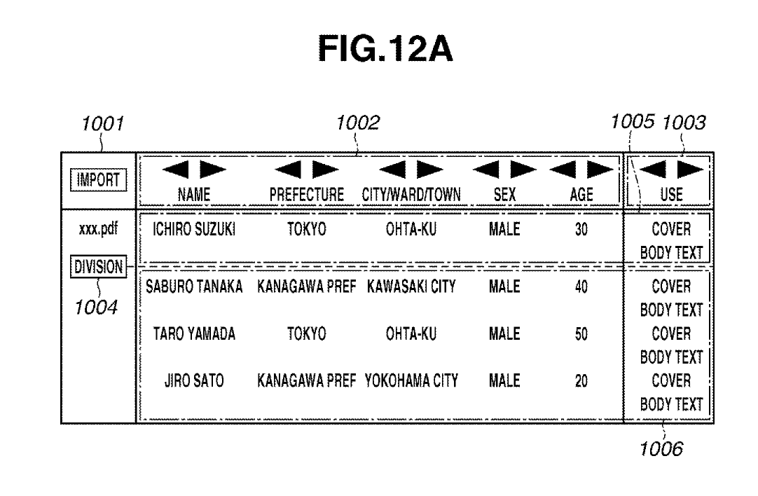

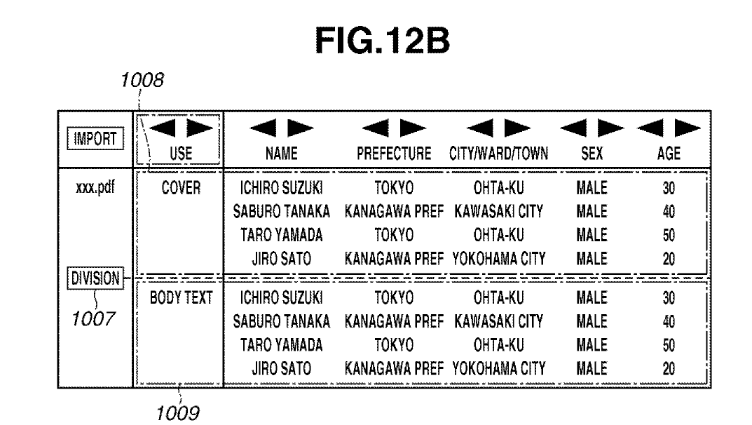

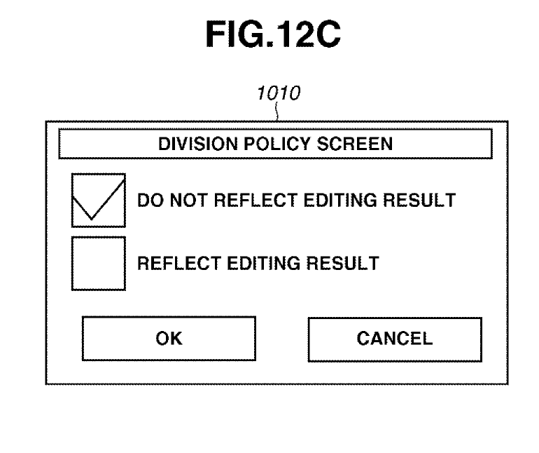

FIG. 12A illustrates an exemplary image of the hierarchical metadata change screen of the UI control unit 301, displaying the hierarchical metadata 304a in FIG. 4A. To simplify the explanation, FIG. 12A illustrates only the first and second layers of the hierarchical metadata 304a in FIG. 4A.

FIG. 12A illustrates a hierarchical metadata change screen 1001.

Afield 1002 indicates that the metadata keys “NAME”, “PREFECTURE”, “CITY/WARD/TOWN”, “SEX”, and “AGE” exist in the first layer. The field 1002 includes grouping and grouping canceling buttons for each key. Pressing these keys performs grouping and cancels grouping.

A field 1003 indicates that a metadata key “USE” exists in the second layer.

When the user presses a DIVISION button 1004, the print document 304 may be divided into a plurality of print documents 304.

The DIVISION button 1004 may be vertically moved to specify a dividing position. FIG. 12A illustrates that the metadata will be divided into two print documents 1005 and 1006. Although only one DIVISION button is displayed, a plurality of DIVISION buttons may be provided and an apply button may be separately provided.

Further, instead of specifying a dividing position, the user may specify a key for automatic division. For example, when division is performed based on all values of the key “PREFECTURE”, the user may specify the key “PREFECTURE” once instead of specifying its values one by one. Then, the print document dividing unit 302 automatically performs division by a key having different values. The UI control unit 301 displays a pop-up window in the hierarchical metadata change screen 1001 to enable the user to specify whether automatic division by a key is performed. Of course, before performing automatic division, the UI control unit 301 may display the DIVISION button 1004 to notify the user of the dividing position.

Further, instead of specifying a dividing position, the user may specify the number of records and file size, and the print document dividing unit 302 determines a dividing position and then performs automatic division. More specifically, when the user specifies division in units of 100 records, the print document dividing unit 302 counts the number of records to automatically adjust the dividing position.

FIG. 12B illustrates an exemplary image of the hierarchical metadata change screen 1001 of the UI control unit, displaying the hierarchical metadata 304a in FIG. 4A after further grouping by the key “USE” is applied thereto.

When the user presses a DIVISION button 1007, the print document dividing unit 302 divides the print document 304 into a plurality of print documents 304. FIG. 12B indicates that the hierarchical metadata 304a resulting from applying grouping by the key “USE” will be divided into two print documents 1008 and 1009. If division will remarkably detract the meaning of the print document 304, the UI control unit 301 grays out the DIVISION button 1007 to disable the user to press it. For example, when the user attempts to divide the print document 1008 (resulting from applying grouping by the key “USE”) between values “SUZUKI ICHIRO” and “SABURO TANAKA” for the key “NAME”, the UI control unit 301 grays out the DIVISION button 1007 to prevent unintended division.

FIG. 12C illustrates an exemplary division policy screen displayed when the user presses the DIVISION button 1004 or 1007 in FIG. 12A or 12B, respectively. Before dividing the imported print document 304, the user may apply grouping to the hierarchical metadata 304a, cancel grouping, and perform such editing operations as addition, modification, and deletion of DParts and metadata. The user may specify in advance whether the editing result is to be reflected to the print document 304 after division. When “DO NOT REFLECT EDITING RESULT” is checked, the print document merging unit 303 does not reflect to the print documents 304 after division the result of grouping and canceling of grouping performed before the user presses the DIVISION button 1004 or 1007. When “REFLECT EDITING RESULT” is checked, the print document merging unit 303 will reflect to the print documents 304 after division the result of grouping and canceling of grouping performed before the user presses the DIVISION button 1004 or 1007. Of course, when “REFLECT EDITING RESULT” is checked, the page order may also be changed depending on the situation. However, when printing is made based on JDF-based printing control, the page order may be changed and, therefore, it is desirable for the user to freely select whether the editing result is to be reflected depending on the work flow used.

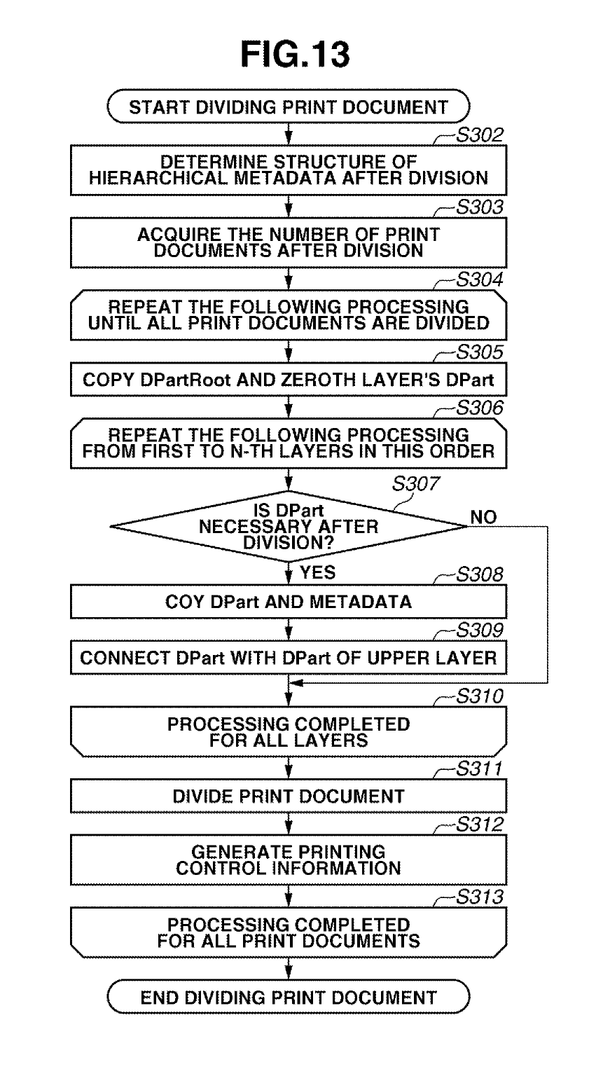

FIG. 13 is a flowchart illustrating processing performed by the print document dividing unit 302 to divide the print document 304 when division is instructed in the hierarchical metadata change screen 1001.

When division is instructed from the UI control unit 301, in operation S302, the print document dividing unit 302 determines the structure of the hierarchical metadata 304a after division. More specifically, the print document dividing unit 302 acquires which option is checked on the division policy screen 1010 (FIG. 12C), and determines which metadata keys exist in which layers of the hierarchical structure. For example, when “DO NOT REFLECT EDITING RESULT” is checked after edition based on the hierarchical structure illustrated in FIG. 12B, the print document dividing unit 302 determines that metadata keys “NAME”, “PREFECTURE”, “CITY/WARD/TOWN”, “SEX”, and “AGE” exist in the first layer, and a metadata key “USE” exists in the second layer. Likewise, when “REFLECT EDITING RESULT” is checked after edition based on the hierarchical structure illustrated in FIG. 12B, the print document dividing unit 302 determines that a metadata key “USE” exits in the first layer, and metadata keys “NAME”, “PREFECTURE”, “CITY/WARD/TOWN”, “SEX”, and “AGE” exist in the second layer. Further, when an unedited hierarchical structure illustrated in FIG. 12A is divided, the print document dividing unit 302 assumes the same structure regardless of whether “REFLECT EDITING RESULT” or “DO NOT REFLECT EDITING RESULT” is checked. More specifically, the print document dividing unit 302 determines that metadata keys “NAME”, “PREFECTURE”, “CITY/WARD/TOWN”, “SEX”, and “AGE” exist in the first layer, and a metadata key “USE” exists in the second layer.

In operation S303, the print document dividing unit 302 acquires the number of print documents after division. For example, with the hierarchical structures illustrated in FIGS. 12A and 12B, “2” is obtained as the number of print documents.

In operations S304 through S313, the print document dividing unit 302 repeats the processing of operations S305 to S312 until all of the print documents 304 are divided.

In operation S305, the print document dividing unit 302 copies the DPartRoot, the DParts of the zeroth layer, and relevant metadata to the print documents 304 at the time of importing. For example, with the hierarchical structures illustrated in FIGS. 12A and 12B, the print document dividing unit 302 copies the DPartRoot 401, the DPart 402, and the metadata 403 and 404 to the hierarchical metadata 304a in FIG. 4A.

In operations S306 through S310, the print document dividing unit 302 repeats the processing of operations S307 to S309 for the first to Nth layers for the print documents 304 at the time of importing. For example, with the hierarchical structures illustrated in FIGS. 12A and 12B, the print document dividing unit 302 processes the first and second layers for the hierarchical metadata 304a in FIG. 4A.

In operation S307, according to the applied dividing position, the print document dividing unit 302 determines whether a DPart is required after division based on the metadata keys and values of DParts and parent-child relations between DParts. When the print document dividing unit 302 determines that a DPart is required (YES in operation S307), the processing proceeds to operation S308. When the print document dividing unit 302 determines that a DPart is not required (NO in operation S307), the processing proceeds to operation S310. For example, the print document firstly divided in the hierarchical structure illustrated in FIG. 12A will be described below. For the first layer, the print document dividing unit 302 determines that the DPart 405 having metadata having a key “NAME” and a value “SUZUKI ICHIRO” is required after division, based on the dividing position specified by the user. For the second layer, the print document dividing unit 302 determines that the DParts 413 and 414, child nodes of the DPart 405 selected for the first layer, having metadata having a key “USE” and a value “COVER” or “BODY TEXT” are required after division. The print document 304 secondly divided in the hierarchical structure illustrated in FIG. 12A will be described below. For the first layer, the print document dividing unit 302 determines that DParts having metadata having a key “NAME” and values “SABURO TANAKA”, “TARO YAMADA”, and “JIRO SATO” are required after division, based on the dividing position specified by the user. More specifically, the DParts 406, 407, and 408 are required after division. For the second layer, the print document dividing unit 302 determines that the DParts 422 and 423, child nodes of the DPart 406 selected for the first layer, having metadata having a key “COVER” or “BODY TEXT” are required. Likewise, for the second layer, the print document dividing unit 302 determines that the DParts 424 and 425, child nodes of the DPart 407 selected for the first layer, having metadata having a key “USE” and a value “COVER” or “BODY TEXT” are required. Finally, for the second layer, the print document dividing unit 302 determines that the DParts 426 and 427, child nodes of the DPart 408 selected for the first layer, having metadata having a key “USE” and a value “COVER” or “BODY TEXT” are required.

In operation S308, the print document dividing unit 302 copies DParts and metadata determined to be required. For example, the print document firstly divided in the hierarchical structure illustrated in FIG. 12A will be described below. For the first layer, the print document dividing unit 302 copies the DPart 405 and the metadata 409. For the second layer, the print document dividing unit 302 copies the DPart 413 and 414 and the metadata 415 and 417. In subsequent explanations, a copy of DPartXXX is represented by CopyXXX_DPart. For example, a copy of the DPart 405 is represented by Copy405_DPart.

In operation S309, the print document dividing unit 302 links between DParts of the zeroth layer copied in operation S305, or between DParts in the N-th layer (N is one or greater) copied in operation S308. For example, for the print document firstly divided in the hierarchical structure illustrated in FIG. 12A, the print document dividing unit 302 links between Copy402_DPart and Copy405_DPart, and between Copy405_DPart, Copy413_DPart, and Copy414_DPart.

In operation S310, the print document dividing unit 302 completes the above processing for all layers, and the processing proceeds to operation S311.

In operation S311, the print document dividing unit 302 divides the print document 304 itself and, when a reusable object is found, generates its copies to be used by respective print documents 304. The print document dividing unit 302 applies grouping to the hierarchical metadata 304a generated in operations S305 to S310 so that the structure predetermined in operation S302 is achieved, and merges the resultant metadata with the print documents 304 generated through division. Of course, when the hierarchical metadata 304a is not edited before division, grouping is not required. For example, when “REFLECT EDITING RESULT” is checked after edition based on the hierarchical structure illustrated in FIG. 12B, the metadata key “USE” needs to exist in the first layer and, therefore, the print document dividing unit 302 will perform grouping by the key “USE.”

In operation S312, the printing control information updating unit 307 generates new printing control information 306, and further updates the key “RECORD LEVEL” of the hierarchical metadata 304a as required. For example, when “REFLECT EDITING RESULT” is checked after edition based on the hierarchical structure illustrated in FIG. 12B, the print document dividing unit 302 performs grouping by the key “USE” and, therefore, updates the key “RECORD LEVEL” to “2”.

In operation S313, the print document dividing unit 302 completes dividing all of the print documents 304, and then this sequence ends.

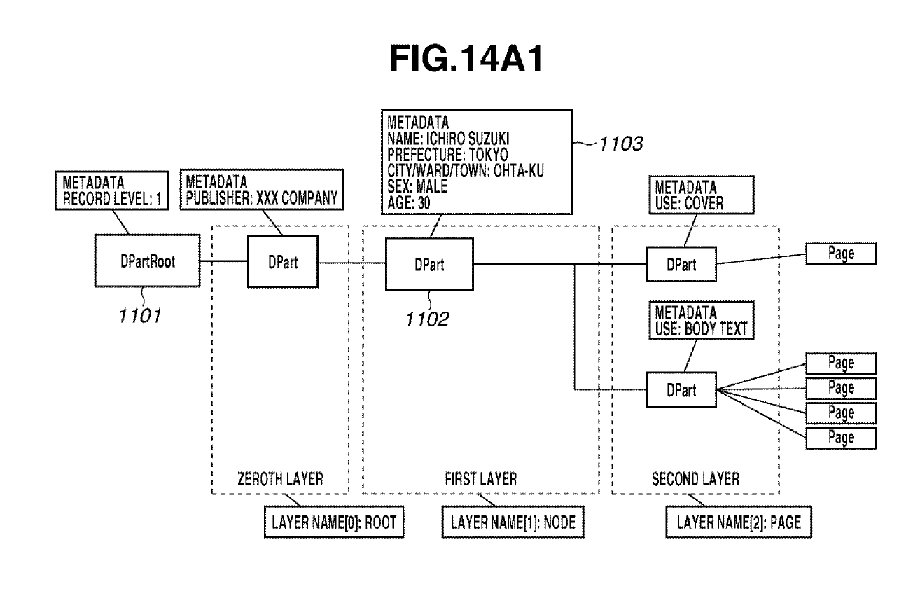

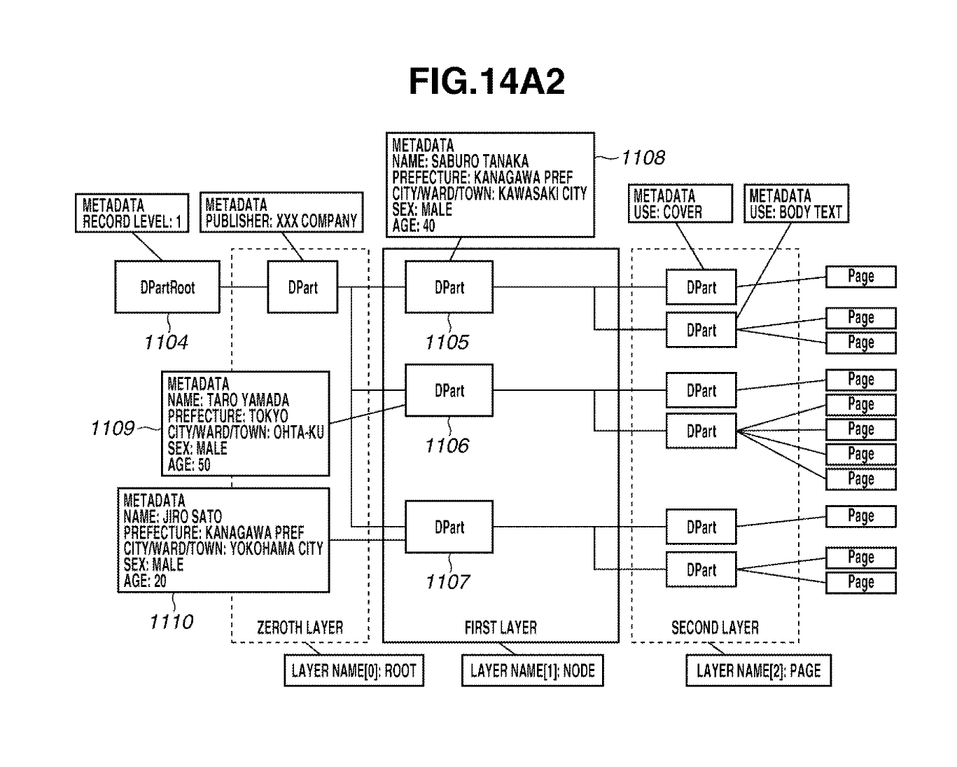

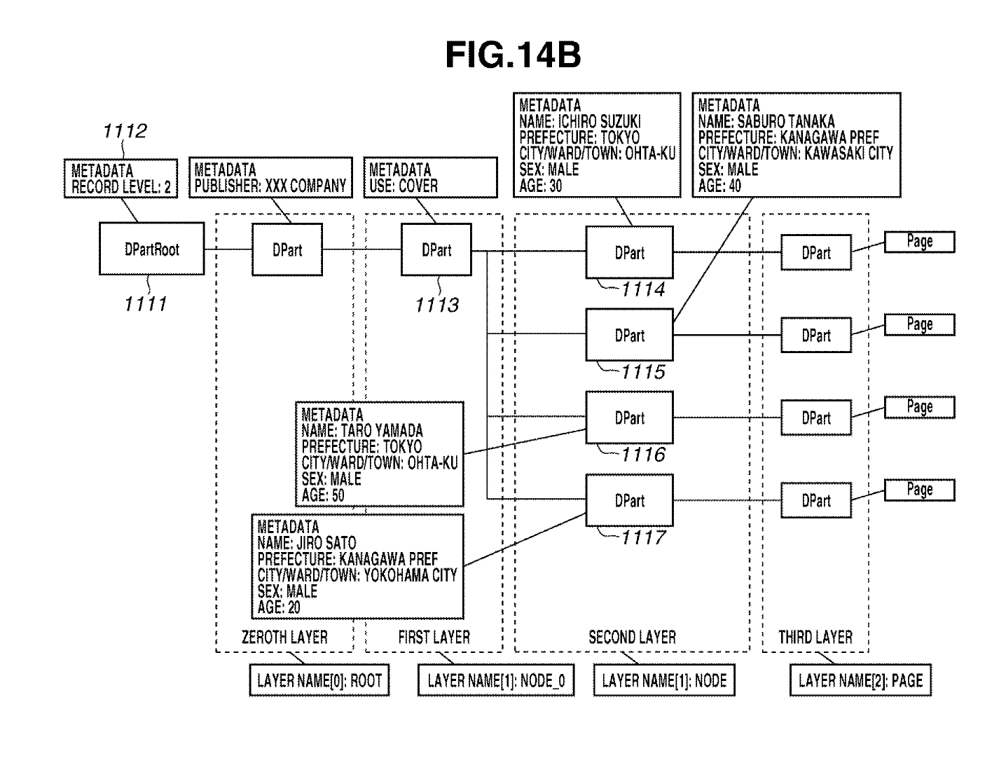

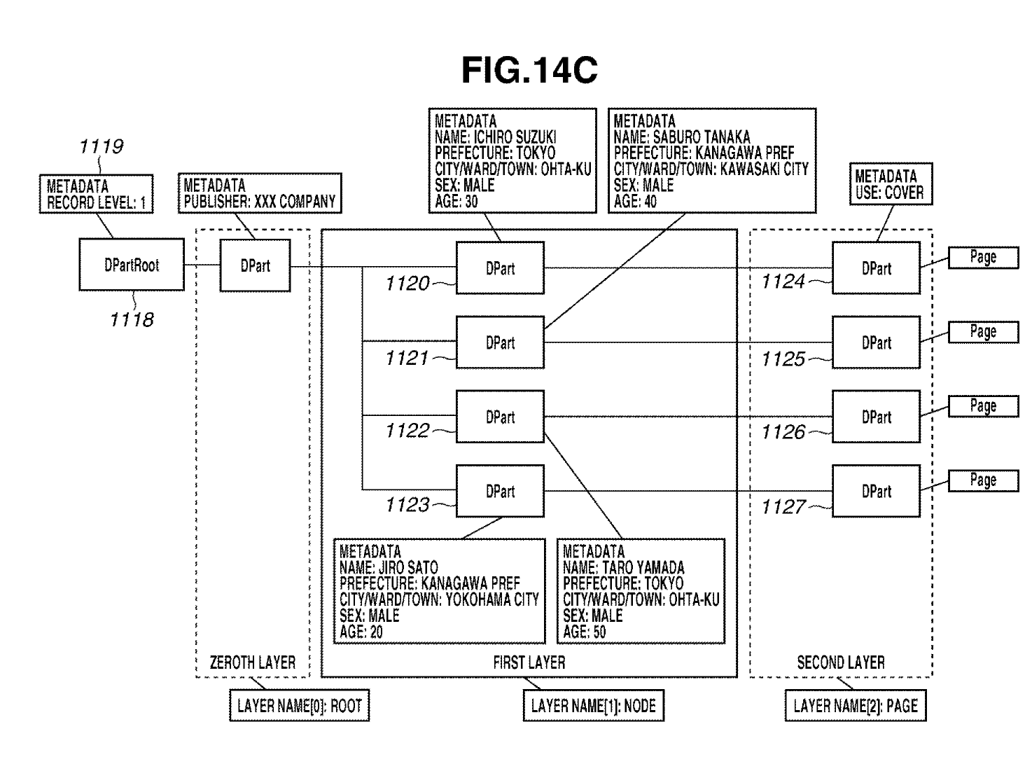

FIGS. 14A1 and 14A2 illustrate exemplary images of divided hierarchical metadata 304a resulting from applying the processing of the flowchart in FIG. 13 to the hierarchical metadata in FIG. 4A. More specifically, FIGS. 14A1 and 14A2 illustrate images of the hierarchical metadata 304a after dividing the hierarchical structure illustrated in FIG. 12A by pressing the DIVISION button 1004 (FIG. 12A) and checking “DO NOT REFLECT EDITING RESULT” in the division policy screen 1010 (FIG. 12C). Referring to FIGS. 14A1 and 14A2, the hierarchical metadata 304a is divided by the key “NAME” and the value “SUZUKI ICHIRO” (FIG. 14A1) and other keys and values (FIG. 14A2) by using the DIVISION button 1004 in FIG. 12A.

A DPartRoot 1101 is a DPartRoot of one hierarchical metadata 304a generated after division (FIG. 14A1). Metadata 1103 having a key “NAME” and a value “SUZUKI ICHIRO” exists in a DPart 1102.

A DPartRoot 1104 is a DPartRoot of the other hierarchical metadata 304a generated after division (FIG. 14A2). Metadata 1108, 1109, and 1110 having a key “NAME” and values “SABURO TANAKA”, “TARO YAMADA”, and “JIRO SATO” exist in DParts 1105, 1106, and 1107, respectively.

FIG. 14B illustrates an exemplary image of hierarchical metadata 304a of the firstly divided print document 304 resulting from applying the processing of the flowchart in FIG. 13 to the hierarchical metadata in FIG. 4A. More specifically, FIG. 14B illustrate an image of the hierarchical metadata 304a after dividing the hierarchical structure illustrated in FIG. 12B by pressing the DIVISION button 1007 (FIG. 12B) and checking “REFLECT EDITING RESULT” in the division policy screen 1010 (FIG. 12C).

A DPartRoot 1111 is a DPartRoot of the hierarchical metadata 304a generated after division.

Metadata 1112 is metadata having a key “RECORD LEVEL” and a value “2”.

A DPart 1113 is a DPart generated by further applying grouping to DPart generated by copies of the DParts 413, 422, 424, and 426 in FIG. 4A.

A DPart 1114 is a DPart generated by a copy of the DPart 405 in FIG. 4A.

A DPart 1115 is a DPart generated by a copy of the DPart 406 in FIG. 4A.

A DPart 1116 is a DPart generated by a copy of the DPart 407 in FIG. 4A.

A DPart 1117 is a DPart generated by a copy of the DPart 408 in FIG. 4A.

The editing result by grouping by the key “USE” is reflected to the hierarchical metadata 304a after division. Therefore, the value of the key “RECORD LEVEL” is updated to “2”.

FIG. 14C illustrates an exemplary image of hierarchical metadata 304a of the firstly divided print document 304 resulting from applying the processing of the flowchart in FIG. 13 to the hierarchical metadata in FIG. 4A. More specifically, FIG. 14C illustrates an image of the hierarchical metadata 304a after dividing the hierarchical structure illustrated in FIG. 12B by pressing the DIVISION button 1007 (FIG. 12B) and checking “DO NOT REFLECT EDITING RESULT” in the division policy screen 1010 (FIG. 12C).

A DPartRoot 1118 is a DPartRoot of the hierarchical metadata 304a generated after division.

Metadata 1119 is metadata having a key “RECORD LEVEL” and a value “1”.

A DPart 1120 is a DPart generated by a copy of the DPart 405 in FIG. 4A.

A DPart 1121 is a DPart generated by a copy of the DPart 406 in FIG. 4A.

A DPart 1122 is a DPart generated by a copy of the DPart 407 in FIG. 4A.

A DPart 1123 is a DPart generated by a copy of the DPart 408 in FIG. 4A.

A DPart 1124 is a DPart generated by a copy of the DPart 413 in FIG. 4A.

A DPart 1125 is a DPart generated by a copy of the DPart 422 in FIG. 4A.

A DPart 1126 is a DPart generated by a copy of the DPart 424 in FIG. 4A.

A DPart 1127 is a DPart generated by a copy of the DPart 426 in FIG. 4A.

The editing result by grouping is not reflected to the hierarchical metadata 304a after division. Therefore, the value of the key “RECORD LEVEL” remains unchanged (“1”).

As described above, the present exemplary embodiment enables dividing the hierarchical metadata 304a and further ensuring the consistency of the printing control information 306 after division. Further, the present exemplary embodiment provides a simple method for editing (dividing) the hierarchical metadata 304a.

According to the above-mentioned exemplary embodiments, print data having a hierarchical structure may be suitably merged and divided.

According to one disclosed aspect of the embodiments, print data having a hierarchical structure may be suitably merged and divided.

Aspects of the embodiments may also be realized by a computer of a system or apparatus (or devices such as a CPU or MPU) that reads out and executes a program recorded on a memory device to perform the functions of the above-described embodiment (s), and by a method, the operations of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable storage medium).

Further, the present exemplary embodiment may also be realized by supplying software (e.g., a program or a set of instructions) for realizing the functions of the above exemplary embodiments to a system or an apparatus via a network or via various storage media, and having a computer (a central processing unit (CPU) or a micro processing unit (MPU)) of the system or apparatus read and execute the program or the instructions recorded/stored on an article of manufacture having a memory device or a non-transitory storage medium to perform operations or functions of the above-described embodiments. In this case, this program and the recording medium on which the program is recorded/stored constitute one disclosed aspect of the embodiments. In addition, the program may be executed by one computer, or by a plurality of computers linked together.

Disclosed aspects of the embodiments may be realized by an apparatus, a machine, a method, a process, or an article of manufacture that includes a non-transitory storage medium having a program or instructions that, when executed by a machine or a processor, cause the machine or processor to perform operations as described above. The method may be a computerized method to perform the operations with the use of a computer, a machine, a processor, or a programmable device. The operations in the method involve physical objects or entities representing a machine or a particular apparatus (e.g., a printing apparatus, print documents). In addition, the operations in the method transform the elements or parts from one state to another state. The transformation is particularized and focused on merging print documents having a hierarchical structure. The transformation provides a different function or use such as receiving an instruction for merging, changing the metadata, and merging the first and second print documents based on the changed metadata, etc.

In addition, elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any optical, electromechanical, electromagnetic, or electronic devices. The term software generally refers to a logical structure, a method, a procedure, a program, a routine, a process, an algorithm, a formula, a function, an expression, etc. A software implementation typically includes realizing the above elements (e.g., logical structure, method, procedure, program) as instruction codes and/or data elements embedded in one or more storage devices and executable and/or accessible by a processor, a CPU/MPU, or a programmable device as discussed above. The term firmware generally refers to a logical structure, a method, a procedure, a program, a routine, a process, an algorithm, a formula, a function, an expression, etc., that is implemented or embodied in a hardware structure (e.g., flash memory). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations.

All or part of an embodiment may be implemented by various means depending on applications according to particular features, functions. These means may include hardware, software, or firmware, or any combination thereof. A hardware, software, or firmware element may have several modules or units coupled to one another. A hardware module/unit is coupled to another module/unit by mechanical, electrical, optical, electromagnetic or any physical connections. A software module/unit is coupled to another module by a function, procedure, method, subprogram, or subroutine call, a jump, a link, a parameter, variable, and argument passing, a function return, etc. A software module/unit is coupled to another module/unit to receive variables, parameters, arguments, pointers, etc. and/or to generate or pass results, updated variables, pointers, etc. A firmware module/unit is coupled to another module/unit by any combination of hardware and software coupling methods above. A hardware, software, or firmware module/unit may be coupled to any one of another hardware, software, or firmware module/unit. A module/unit may also be a software driver or interface to interact with the operating system running on the platform. A module/unit may also be a hardware driver to configure, set up, initialize, send and receive data to and from a hardware device. An apparatus may include any combination of hardware, software, and firmware modules/units.

While the embodiments have been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-274800 filed Dec. 9, 2010, which is hereby incorporated by reference herein in its entirety.

What is claimed is:

1. An information processing apparatus comprising:
a receiving unit configured to receive from a user an instruction for merging first and second print documents having a hierarchical structure including layers to which metadata are attached;
a determination unit configured to, in response to the instruction received by the receiving unit, determine whether a combination of keys included in metadata of the first print document coincides with a combination of keys included in metadata of the second print document with respect to each of the layers in the hierarchical structures of the first and second print documents;
a changing unit configured to, when the determination unit determines that the combination of keys included in the metadata of the first print document does not coincide with the combination of keys included in the metadata of the second print document, change at least one of the metadata of the first print document and the metadata of the second print document so that the combination of keys included in the metadata of the first print document coincides with the combination of keys included in the metadata of the second print document with respect to each of the layers in the hierarchical structures of the first and second print documents; and
a merging unit configured to merge the first and second print documents based on the metadata obtained through change processing by the changing unit.

2. The information processing apparatus according to claim 1, wherein, when the determination unit determines that the combination of keys included in the metadata of the first print document does not coincide with the combination of keys included in the metadata of the second print document, and that a common key is included in the metadata of the first and second print documents for a layer determined to be mismatched by the determination unit, the changing unit applies grouping to the layer determined to be mismatched, and wherein, when the determination unit determines that the combination of keys included in the metadata of the first print document does not coincide with the combination of keys included in the metadata of the second print document, and that no common key is included in the metadata of the first and second print documents for a layer determined to be mismatched by the determination unit, the changing unit cancels grouping of the layer determined to be mismatched, thus changing at least one of the metadata of the first print document and the metadata of the second print document.

3. An information processing apparatus comprising:
a receiving unit configured to receives from a user an instruction for merging a plurality of print documents having a hierarchical structure including layers to which metadata are attached; and
a merging unit configured to acquire all keys of the metadata attached to the plurality of print documents, determine a hierarchical structure of a print document to be formed after merging, change the metadata of the plurality of print documents to achieve the determined hierarchical structure, and merge the plurality of print documents.

4. The information processing apparatus according to claim 3, wherein the merging unit further acquires all keys of the metadata attached to the plurality of print documents, determines whether all of the keys exist in the metadata attached to the plurality of print documents, and adds, for each of a plurality of insufficient documents having metadata in which any of all of the keys is nonexistent, the nonexistent key to the metadata of the insufficient documents.

5. The information processing apparatus according to claim 1, further comprising:
an updating unit configured to update printing control information for controlling printing corresponding to the print document formed after merging by the merging unit.

6. A computer-readable recording medium storing instructions that, when executed by a processor, cause the processor to perform operations comprising:
receiving from a user an instruction for merging first and second print documents having a hierarchical structure including layers to which metadata are attached;
determining, in response to the received instruction, whether a combination of keys included in metadata of the first print document coincides with a combination of keys included in metadata of the second print document with respect to each of the layers in the hierarchical structures of the first and second print documents;
changing, when the combination of keys included in the metadata of the first print document does not coincide with the combination of keys included in the metadata of the second print document, at least one of the metadata of the first print document and the metadata of the second print document so that the combination of keys included in the metadata of the first print document coincides with the combination of keys included in the metadata of the second print document with respect to each of the layers in the hierarchical structures of the first and second print documents; and
merging the first and second print documents based on the metadata obtained through change processing.

7. The recording medium according to claim 6, wherein, when the combination of keys included in the metadata of the first print document does not coincide with the combination of keys included in the metadata of the second print document, and that a common key is included in the metadata of the first and second print documents for a layer determined to be mismatched, the changing applies grouping to the layer determined to be mismatched, and wherein, when the combination of keys included in the metadata of the first print document does not coincide with the combination of keys included in the metadata of the second print document, and that no common key is included in the metadata of the first and second print documents for a layer determined to be mismatched, the changing cancels grouping of the layer determined to be mismatched, thus changing at least one of the metadata of the first print document and the metadata of the second print document.

8. The recording medium according to claim 6, wherein the recording medium further stores instructions that, when executed by the processor, cause the processor to perform operations comprising:
updating printing control information for controlling printing corresponding to the print document formed after merging by the merging unit.

9. A method for processing information, comprising:
receiving from a user an instruction for merging first and second print documents having a hierarchical structure including layers to which metadata are attached;
determining, in response to the received instruction, whether a combination of keys included in metadata of a first print document coincides with a combination of keys included in metadata of a second print document with respect to each of the layers in the hierarchical structures of the first and second print documents;
changing, when the combination of keys included in the metadata of the first print document is determined not to coincide with the combination of keys included in the metadata of the second print document, at least one of the metadata of the first print document and the metadata of the second print document so that the combination of keys included in the metadata of the first print document coincides with the combination of keys included in the metadata of the second print document with respect to each of the layers in the hierarchical structures of the first and second print documents; and
merging the first and second print documents based on the changed metadata.

10. The method according to claim 9, further comprising:
applying, when the combination of keys included in the metadata of the first print document is determined not to coincide with the combination of keys included in the metadata of the second print document, and a common key is included in the metadata of the first and second print documents for a layer determined to be mismatched, grouping to the layer determined to be mismatched; and canceling, when the combination of keys included in the metadata of the first print document is determined not to coincide with the combination of keys included in the metadata of the second print document, and no common key is included in the metadata of the first and second print documents for a layer determined to be mismatched, grouping of the layer determined to be mismatched, thus changing at least one of the metadata of the first print document and the metadata of the second print document.

11. The method according to claim 9, further comprising:
updating printing control information for controlling printing corresponding to the print document formed after merging the first and second print documents.
